(19) United States
(12) Patent Application Publication
(10) Pub. No.: US 2016/0247295 A1
(43) Pub. Date: Aug. 25, 2016

(54) MITIGATING BACKLIGHT DEFICIENCIES BY USING PIXEL PROCESSING

(71) Applicant: Sony Corporation, Tokyo (JP)

(72) Inventors: Jim Rasmusson, Lund (SE); Martin Ek, Lund (SE)

(21) Appl. No.: 14/354,152

(22) PCT Filed: Nov. 15, 2013
(86) PCT No.: PCT/IB2013/002560

§ 371 Date: Apr. 25, 2014

(51) Int. Cl. G06T 11/00; G06T 1/60; G06T 1/20

(52) U.S. Cl. CPC G06T 11/001; G06T 1/20; G06T 1/60

(57) ABSTRACT

The invention is directed to systems, methods and computer program products for backlight compensation processing associated with a display. An exemplary method comprises: receiving data associated with a backlight, the backlight being associated with a display; determining a compensation parameter based on the data; and applying the compensation parameter to the display.

### BACKGROUND ART

Producing displays is a complicated and costly process. The push for achieving an acceptable production yield is high since each lost display and every repair is expensive. At the same time, the price pressure in the market is high due to the goal of maintaining a high production capacity. Many optical parameters that can lead to yield losses can be tied to variations over the display active area. These variations are associated with parameters such as brightness, uniformity, color unevenness, etc., which can be hard to control in production. The variations occur in different ways for liquid crystal displays (LCDs) and organic light emitting diode displays (OLEDs). Even if some of these parameters do not lead to yield losses, not meeting standards associated with these parameters may prevent optimization of image performance. Therefore, remedying the variation of optical properties associated with a display surface can give opportunities to save money and/or increase display performance

### SUMMARY

Embodiments of the invention are directed to systems, methods and computer program products for backlight compensation processing. An exemplary method comprises: receiving, using a computing device processor, data associated with a backlight, the backlight being associated with a display; determining, using a computing device processor, a compensation parameter based on the data; and applying, using a computing device processor, the compensation parameter to the display.

In some embodiments, the receiving step comprises capturing, during production of the backlight, an image of the backlight.

In some embodiments, the compensation parameter comprises at least one of a timebased compensation parameter or a space-based compensation parameter.

In some embodiments, the compensation parameter comprises a color compensation parameter.

In some embodiments, the compensation parameter comprises an intensity compensation parameter.

In some embodiments, the compensation parameter is determined for a single pixel associated with the display.

In some embodiments, the compensation parameter is determined for a pixel grid associated with the display, wherein the pixel grid comprises at least two pixels.

In some embodiments, the compensation parameter is determined based on interpolating at least one known compensation parameter associated with the pixel grid.

In some embodiments, at least one of the data or the compensation parameter is stored in a memory associated with the display.

In some embodiments, the applying step comprises applying the compensation parameter to an image on the display.

In some embodiments, the applying step is further based on access to primary color data.

In some embodiments, the applying step is performed in a processing pipeline associated with the display.

In some embodiments, the display comprises at least one of a liquid crystal display

(LCD), organic light emitting diode display (OLED), or field sequential color (FSC) display.

In some embodiments, an apparatus is provided for backlight compensation processing. The apparatus comprises: a memory; a processor; and a module stored in the memory, executable by the processor, and configured to: receive data associated with a backlight, the backlight being associated with a display; determine a compensation parameter based on the data; and apply the compensation parameter to the display.

In some embodiments, a computer program product is provided for backlight compensation processing. The computer program product comprises a non-transitory computer-readable medium comprising a set of codes for causing a computer to: receive data associated with a backlight, the backlight being associated with a display; determine a compensation parameter based on the data; and apply the compensation parameter to the display.

### BRIEF DESCRIPTION OF DRAWINGS

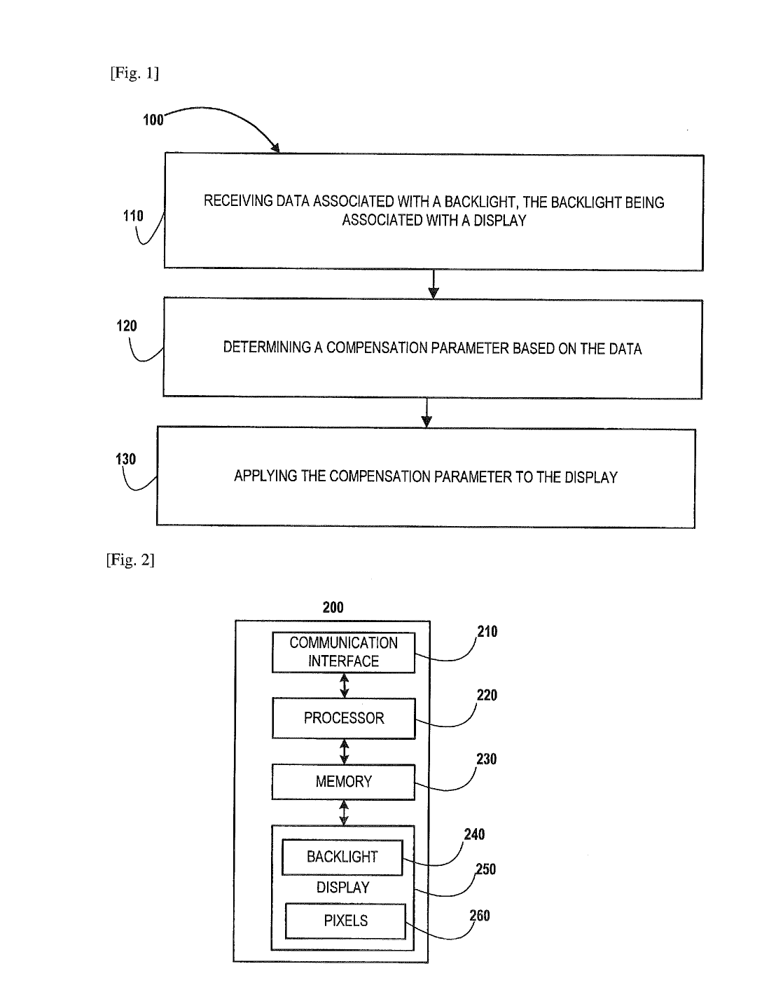

Having thus described embodiments of the invention in general terms, reference will now be made to the accompanying drawings, where:

[fig.1]FIG. 1 is an exemplary process flow for backlight compensation processing, in accordance with embodiments of the present invention;

[fig.2]FIG. 2 is an exemplary device for performing backlight compensation processing, in accordance with embodiments of the present invention.

### DESCRIPTION OF EMBODIMENTS

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for backlight compensation processing. The present invention is directed to using an image-capturing device (e.g., a calibrated camera) to capture images of a backlight in production and then using these images to calculate compensation parameters that are applied to a display panel (e.g., an LCD panel) that includes the backlight. These compensation parameters are applied in the pixel processing pipeline, either in hardware or software. For a software-based solution, a graphics processor is provided to perform the backlight compensation processing. As used herein, a backlight is a form of illumination that enables a display to produce a visual image.

Subsequently the images are analyzed and compensation parameters are calculated. The compensation parameters can be calculated in red-green-blue (RGB) color space, thereby making it possible to compensate for both brightness (intensity) and color. The compensation parameters can be calculated for a single pixel or a pixel grid comprising at least two pixels.

As used herein, a pixel, comprising one or more sub-pixels, is a controllable element associated with a display panel. For example, for a 1280×720 pixel display panel, compensation values are calculated per 16×16 pixel area. Hence, instead of having 1280×720 (921600) compensation parameters, the invention reduces the number of parameters to 80×45=3600 (1280/16=80, 720/16=45) parameters.

In embodiments where there are fewer compensation parameters than pixels, the present invention uses interpolation (e.g., bi-linear interpolation) to determine compensation values for pixels located in-between other pixels that have known compensation parameters. For example, a compensation parameter for a particular pixel inside a 16×16 pixel grid is generated based on bi-linearly interpolating at least one or all of the surrounding four compensation parameters associated with each corner pixel of the quadrilateral 16×16 pixel grid.

As described herein, the invention is also directed to addressing uniformity of brightness associated with a display panel. In order to address this issue, the present invention may use local backlight data associated with individual pixels of the display. In other embodiments, the present invention uses backlight data associated with larger areas (comprising at least two pixels). In some embodiments, the data includes resolution-corresponding pixel size data. In some embodiments, the data is stored on the display panel itself (e.g., in a memory associated with the display panel).

When displaying an image on a display panel, the backlight data associated with the display pixels is compensated by the processor associated with the display panel (e.g., a graphics processor) using the stored data. As described herein, the present invention is directed to brightness compensation and color variation compensation. For brightness compensation, compensation to luminance is calculated on each pixel or pixel grid (comprising more than one pixel). For color variation compensation, compensation to color is also calculated on each pixel or pixel grid. In some embodiments, primary color data is required for color variation compensation (not required for brightness uniformity compensation). The color variation compensation parameter data comprises more data (which requires more processing capacity) compared to the brightness compensation parameter data.

The invention described herein can be used both for time divised (or time based) compensation and spatially divised (or space based) compensation. For example, data associated with a backlight of a display panel is used by a processor (e.g., a graphical processor) to compensate, over a period of time, an image produced on the display. The compensation has the effect of reducing local variation of colors (e.g., primary colors) associated with the display. Time based and space based compensation can be used for LCDs, OLEDs, and field sequential color (FSC) displays. Low brightness or individual sub-pixels with low brightness cause color variations and yield loss for these displays. The present invention can be used to perform at least one of time based or space based compensation to rectify the color variations and yield loss for these displays.

Referring now to FIG. 1, FIG. 1 describes an exemplary process flow 100 for backlight compensation processing. At step 110, the process flow comprises receiving, using a computing device processor, data associated with a backlight, the backlight being associated with a display. At step 120, the process flow comprises determining, using a computing device processor, a compensation parameter based on the data. At step 130, the process flow comprises applying, using a computing device processor, the compensation parameter to the display.

Referring now to FIG. 2, FIG. 2 displays an exemplary computing device or system 200 that performs backlight compensation processing. The device includes a communication interface 210, a display 250 (comprising a backlight 240 and pixels 260), a processor 220, a memory 230, and a module stored in the memory, executable by the processor 220, and configured to perform the various processes described herein, including performing backlight compensation processing. The display 250 comprises one or more pixels 260, wherein each pixel comprises one or more subpixels. Additionally, the display is associated with a backlight 240 that illuminates the display and enables visual images to be viewed on the display.

The processor 220 described herein generally includes circuitry for implementing audio, visual, and/or logic functions. For example, the processor 220 may include a digital signal processor device, a microprocessor device, and various analog-to-digital converters, digital-to-analog converters, and other support circuits. The processor 220 may also include functionality to operate one or more software programs based at least partially on computer-executable program code portions thereof, which may be stored, for example, in a memory 230.

The memory 230 may include any computer-readable medium. For example, the memory 230 may include volatile memory, such as volatile random access memory (RAM) having a cache area for the temporary storage of information. The memory 230 may also include non-volatile memory, which may be embedded and/or may be removable. The non-volatile memory may additionally or alternatively include an EEPROM, flash memory, and/or the like. The memory 230 may store any one or more of pieces of information and data (e.g., data associated with the backlight, compensation parameters, etc.).

The various features described with respect to any embodiments described herein are applicable to any of the other embodiments described herein. Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable readonly memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Pert Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable information processing apparatus in order to produce a particular machine, such that the one or more computer-executable program code portions, which execute via the processor of the computer and/or other programmable information processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable information processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable information processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A method for backlight compensation processing, the method comprising:
receiving, using a computing device processor, data associated with a backlight, the backlight being associated with a display;
determining, using a computing device processor, a compensation parameter based on the data; and
applying, using a computing device processor, the compensation parameter to the display.

2. The method of claim 1, wherein the receiving step comprises capturing, during production of the backlight, an image of the backlight.

3. The method of claim 1, wherein the compensation parameter comprises at least one of a time-based compensation parameter or a space-based compensation parameter.

4. The method of claim 1, wherein the compensation parameter comprises a color compensation parameter.

5. The method of claim 1, wherein the compensation parameter comprises an intensity compensation parameter.

6. The method of claim 1, wherein the compensation parameter is determined for a single pixel associated with the display.

7. The method of claim 1, wherein the compensation parameter is determined for a pixel grid associated with the display, wherein the pixel grid comprises at least two pixels.

8. The method of claim 7, wherein the compensation parameter is determined based on interpolating at least one known compensation parameter associated with the pixel grid.

9. The method of claim 1, wherein at least one of the data or the compensation parameter is stored in a memory associated with the display.

10. The method of claim 1, wherein the applying step comprises applying the compensation parameter to an image on the display.

11. The method of claim 1, wherein the applying step is further based on accessing primary color data.

12. The method of claim 1, wherein the applying step is performed in a processing pipeline associated with the display.

13. The method of claim 1, wherein the display comprises at least one of a liquid crystal display (LCD), organic light emitting diode display (OLED), or field sequential color (FSC) display.

14. An apparatus for backlight compensation processing, the apparatus comprising:
a memory;
a processor; and
a module stored in the memory, executable by the processor, and configured to:
receive data associated with a backlight, the backlight being associated with a display;
determine a compensation parameter based on the data; and
apply the compensation parameter to the display.

15. A computer program product for backlight compensation processing, the computer program product comprising:
a non-transitory computer-readable medium comprising a set of codes for causing a computer to:
receive data associated with a backlight, the backlight being associated with a display;
determine a compensation parameter based on the data; and
apply the compensation parameter to the display.
